(19) United States
(12) Patent Application Publication
(10) Pub. No.: US 2016/0103435 A1
(43) Pub. Date: Apr. 14, 2016

(54) Control System for Process Equipment with Prioritized Instructions

(71) Applicant: Fluid Measurement, LLC, Sarasota, FL (US)

(72) Inventor: Roy Moore, Plant City, FL (US)

(21) Appl. No.: 14/514,002

(22) Filed: Oct. 14, 2014

(51) Int. Cl. G05B 19/042

(52) U.S. Cl. CPC G05B 19/0421; G05B 2219/25252

(57) ABSTRACT

Disclosed is a system for controlling process equipment. In particular, the disclosure relates to system for prioritizing instructions to process equipment over a common serial or parallel port. By way of the system, process equipment to be monitored and controlled by one or more remote users. The prioritized instructions can relate to, for example, data logging and control functions. The system also employs a web client that permits the requesting user to monitor the process equipment via a web browser.

### TECHNICAL FIELD

This disclosure relates to a control system for process equipment. In particular, the disclosure relates to a system controlling process equipment wherein instructions are prioritized on the basis of pre-determined criteria.

### BACKGROUND OF THE INVENTION

Control systems are widely used to control and regulate factory machinery. Applications for control systems include municipal water plants, sewage treatment plans, power plants, residential and commercial pools, as well as environmental control systems. Control systems are designed to transmit system status information such that the systems can be appropriately monitored by human operators. Control systems typically collect information on a variety of parameters, including fluid pressures, flow rates, temperatures, and various operational or non-operational statuses. Audible or visual alarms may be triggered when one or more of these parameters is not within pre-set limits.

Currently, control systems enjoy a limited degree of automation via the use of Programmable Logic Controllers (PLC). PLCs are used to read a set of digital or analog inputs. One or more logic statements are applied to the inputs to generate analog or digital outputs. Larger and more complex systems can be controlled via Distributed Control Systems (DCS). It is also known within the art to use a central master computer to monitor and control an array of module drivers inside a Remote Terminal Unit (RTU). The modules collect and transmit sensor data in the form of analog signals and in turn actuate switches, solenoids, and the like to the process equipment.

One example of a prior art system is disclosed in U.S. Pat. No. 6,035,240 to Moorehead et al. Moorehead discloses a flexible distributed processing system for sensor data acquisition and control. The system includes a series of nodes and sensors for measuring a predetermined parameter. In particular, Moorehead discloses a correction means at each sensor for storing corrections between the voltage signal and the standard output voltage. In this manner, all of the sensors look the same to the central control unit.

U.S. Pat. No. 8,424,024 to Remmert discloses an application specific serial port redirector. It discloses a system wherein serial device requests from an application are redirected to a plurality of serial devices over a computer network. Each serial device request may be associated with a specific application protocol and transport protocol.

Although each of the prior systems achieves its own unique and individual objective, all suffer from common drawbacks. In particular, prior systems to do not allow for instructions to be prioritized over a single communications port. Nor do prior systems allow for such prioritization utilizing TCP/IP or other standardized protocols. Thus, there is continuing need in the art to enable process equipment to prioritize instructions.

### SUMMARY OF THE INVENTION

This disclosure relates to a control system for process equipment. In accordance with the disclosure, process equipment is controlled via prioritized instructions. The prioritization can be based upon pre-determined criteria.

The disclosed system has several important advantages. For example, it allows instructions to be sent or received over a common communications port.

A further advantage is realized by allowing different instructions to be prioritized while using standardized communications protocols.

A further possible advantage is the ability to remotely monitor and control process equipment over an Internet connection in a secure manner.

Still yet another possible advantage of the present system is to ensure that a remote system remains within set parameters via data logging and on-line monitoring.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a schematic diagram of the system of the present disclosure.

FIG. 2 is a flow chart showing the main system loop of the present disclosure.

FIG. 3 is a flow chart showing the operation of the data logging feature of the present disclosure.

FIG. 4 is a flow chart showing the operation of the web client feature of the present disclosure.

FIG. 5 illustrates how instructions are received or processed by the controller of the present disclosure.

FIG. 6 illustrates how instructions are received or processed by the controller of the present disclosure.

Similar reference numerals refer to similar parts throughout the several views of the drawings.

### DETAILED DESCRIPTION OF THE DRAWINGS

The present disclosure relates to system for controlling process equipment. In particular, the disclosure relates to system for prioritizing instructions to process equipment over a common serial or parallel port. By way of the system, process equipment can be monitored and controlled by one or more remote users. The prioritized instructions can relate to, for example, data logging and control functions. The system also employs a web client that permits the requesting user to monitor the process equipment via a web browser. The various features of the present disclosure are more fully described hereinafter.

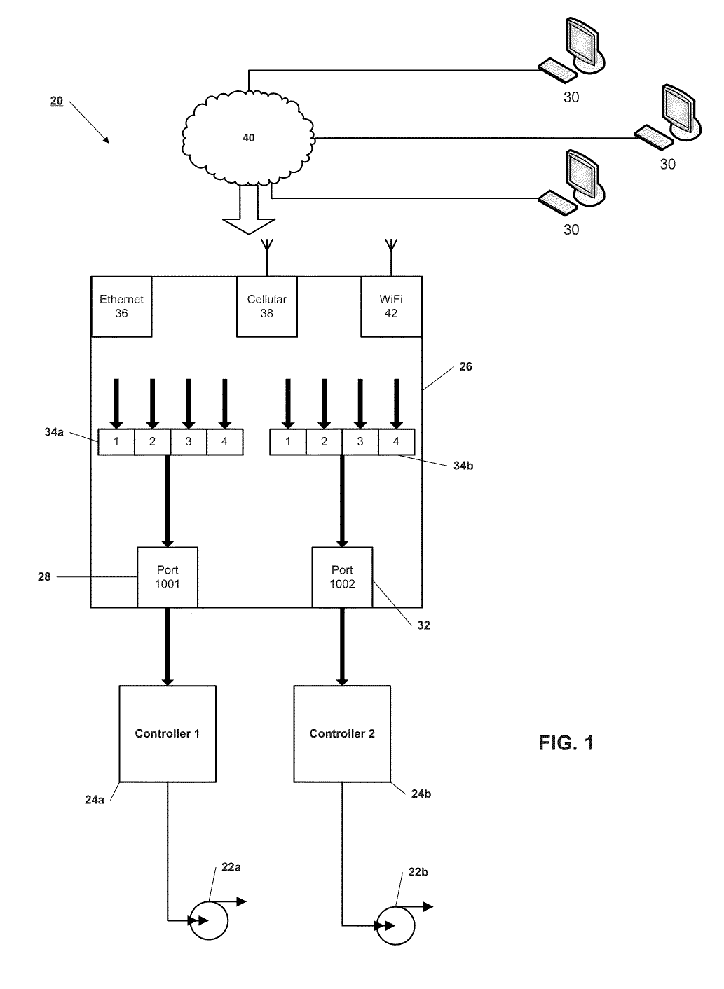

FIG. 1 is a schematic depiction of the system 20 of the present disclosure. As illustrated, system 20 includes one or more computers/servers 30 that communicate with a processor 26 over a network 40. Processor 26, in turn, communicates with process equipment 22 via a controller 24. In the depicted embodiment, processor 26 communicates with two different pieces of equipment (22a and 22b) via separate controllers (24a and 24b). The present system 20 can be used in connection with one or more individual pieces of equipment and one or more individual controllers. Computers 30 may communicate with processor 26 via an Ethernet connection 36. Alternatively, computers 30 may communicate with processor 26 via a cellular connection 38 or WiFi connection 42.

Computer network 40 can be any of a variety of networks, such as the Internet, a Local Area Network (LAN), Wide Area Network (WAN), or Personal Area Network (PAN). As described hereinafter, instructions from computers 30 may be formatted in accordance with a standardized transmission protocol, such as Transmission Control Protocol/Internet Protocol (“TCP/IP”), User Datagram Protocol (UDP), or Telnet and Secure Sockets Layer (SSL). Non-standard, proprietary protocols may also be used. These protocols may be unique to the specified process equipment 22 and/or equipment controller 24. Ultimately, the instructions are delivered to an associated controller (24a or 24b) via processor 26. Processor 26 functions to prioritize the instructions in accordance with pre-determined criterion. As a result, process equipment (22a or 22b) can receive varying instructions and can carry out distinct tasks and operations.

This process equipment may include, for example, pumps, valves, flow controllers, or any other process machinery. In the depicted example, two pumps 22 are controlled by associated controllers 24. Although two pieces of equipment are illustrated, any number can be employed in connection with the disclosed system 20. In the depicted embodiment, a first pump 22a is controlled by a first controller 24a and a second pump 22b is controlled by a separate and independent controller 24b. Both controllers (24a and 24b) receive instructions from computers 30 via processor 26. Processor 26, which may be a microprocessor or microcontroller, is operated by an operating system, such as Windows or Linux. Controllers (24a and 24b) are connected to processor 26 via one or more ports (28 and 32). These may be, for example, serial or parallel ports associated with the microprocessor. In the illustrative example, the first controller 24a communicates over port 28 and the second controller 24b communicates over port 32.

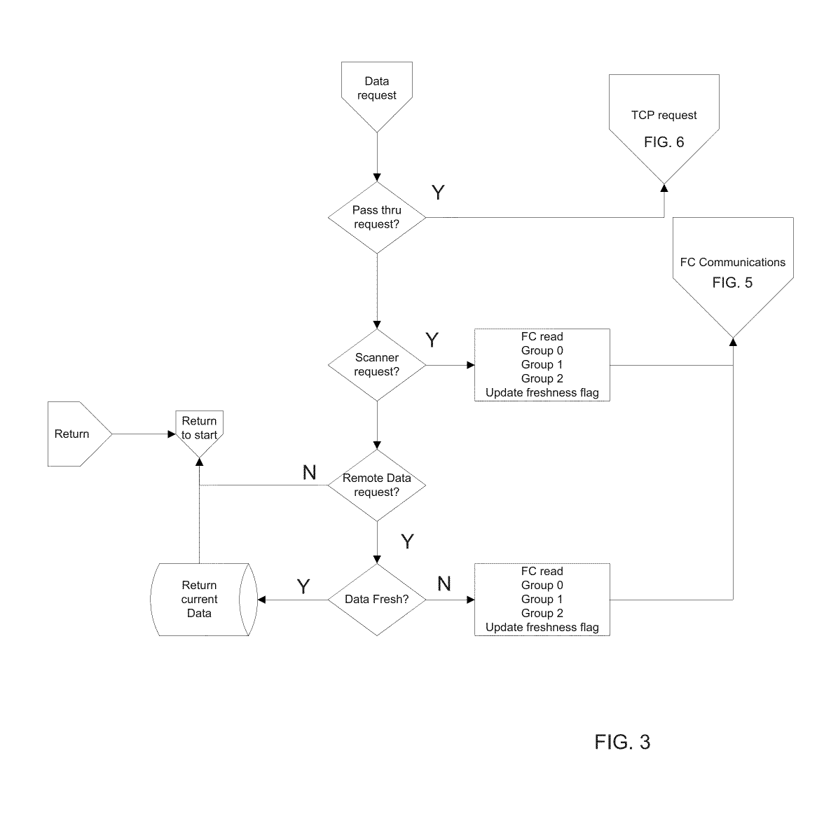

A port redirector (34a and 34b) is associated with each port (28 and 32). Again, the depicted embodiment illustrates two redirectors (34a and 34b), but any number can be employed. Both port redirectors are identical and so only one is described in detail. The port director 34 accepts one of a series of external instructions received by processor 26. These external instructions can be received via an Ethernet connection 36, cellular connection 38, or WiFi connection 42. Each port redirector 34 operates in accordance with programming stored within the memory of processor 26. The redirector prioritizes the external instructions in accordance with pre-defined requirements of the controller (24a and 24b) and associated process equipment (22a and 22b). As illustrated in FIG. 1, each redirector 34 includes four ports (1, 2, 3, and 4) for receiving one of four different external instructions. Each of the ports (1, 2, 3, and 4) processes the instructions in accordance with a stored subroutine. The operation of these subroutines is illustrated via in FIGS. 3, 4, 5, and 6.

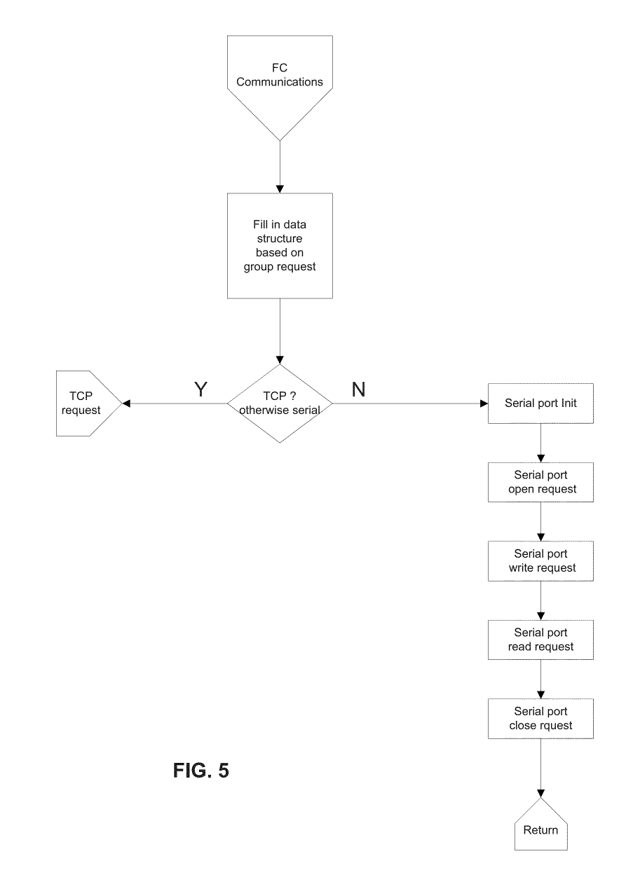

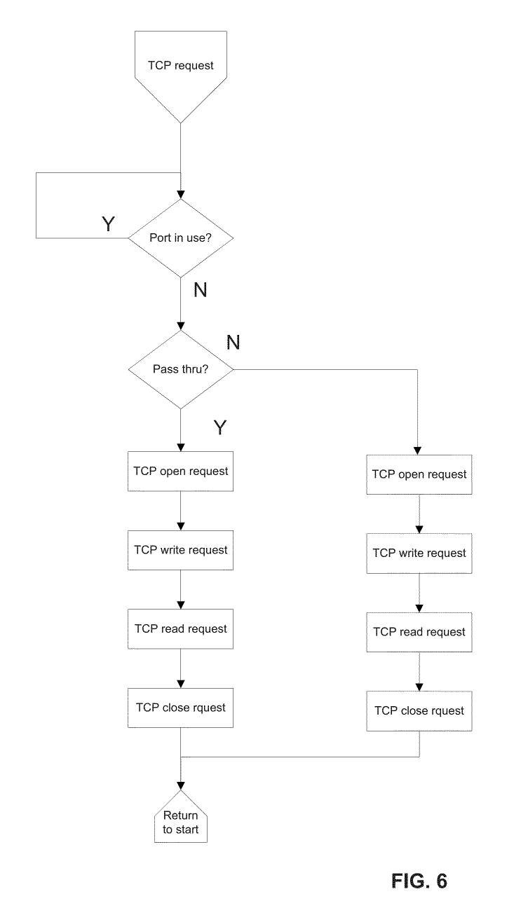

In the preferred embodiment, port 1 is a channel that is dedicated to delivering instructions for the operation of the process equipment (22 or 22). These instructions would be unique to the specific controller application. For example, the controllers and associated applications may be proprietary, such as those provided by Danfoss Group or Penta Air. Instructions over port 1 may use a tunneling protocol to provide a secure path to the associated controller (24a or 24b). The flow charts of FIGS. 5 and 6 illustrate how instructions are received and processed by the associated controller and process equipment. FIG. 5 illustrates that an incoming instruction is processed either in accordance with TCP or via a serial port. If the instructions are delivered to a serial port, the subroutine issues the following requests: open port, write request, read request, and close request. TCP requests are processed in accordance with the subroutine of FIG. 6. If a port if free, the subroutine cycles through an open request, a write request, a read request and a close request. Again, the overall function of these subroutines is to operate the process equipment in accordance with the particular needs of the system.

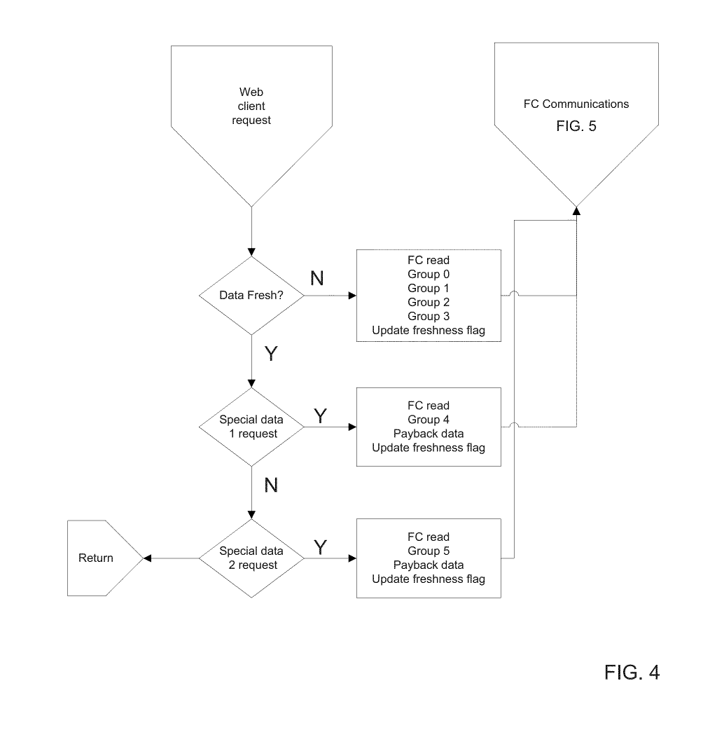

Port 2 is a dedicated data gathering channel. This channel can be used to retrieve metrics regarding the function and operation of the associated process equipment (22a or 22b). The data gathered over port 2 can include, for example, the RPM of associated pump motors, flow rates (via flow meters), flow pressures, and other relevant data. The data would be remotely transmitted to personnel via the Ethernet connection 36, cellular connection 38, or WiFi connection 42. The collected data would permit the personnel to determine whether the process equipment was operating within accepted parameters. Port 2 could form part of a supervisory control and data acquisition system. The flow chart of FIG. 3 illustrates the subroutine for gathering and logging data. Port 3 similarly allows a remote user to access the controller over the internet via a web browser. Thus, port 3 is dedicated for HTTP clients (typically over TCP port 80). Any of a variety of control or monitoring features can be provided via this port. The flow chart of FIG. 4 illustrates how the requests would be processed over this port. Finally, port 4 can be reserved or utilities for miscellaneous external applications.

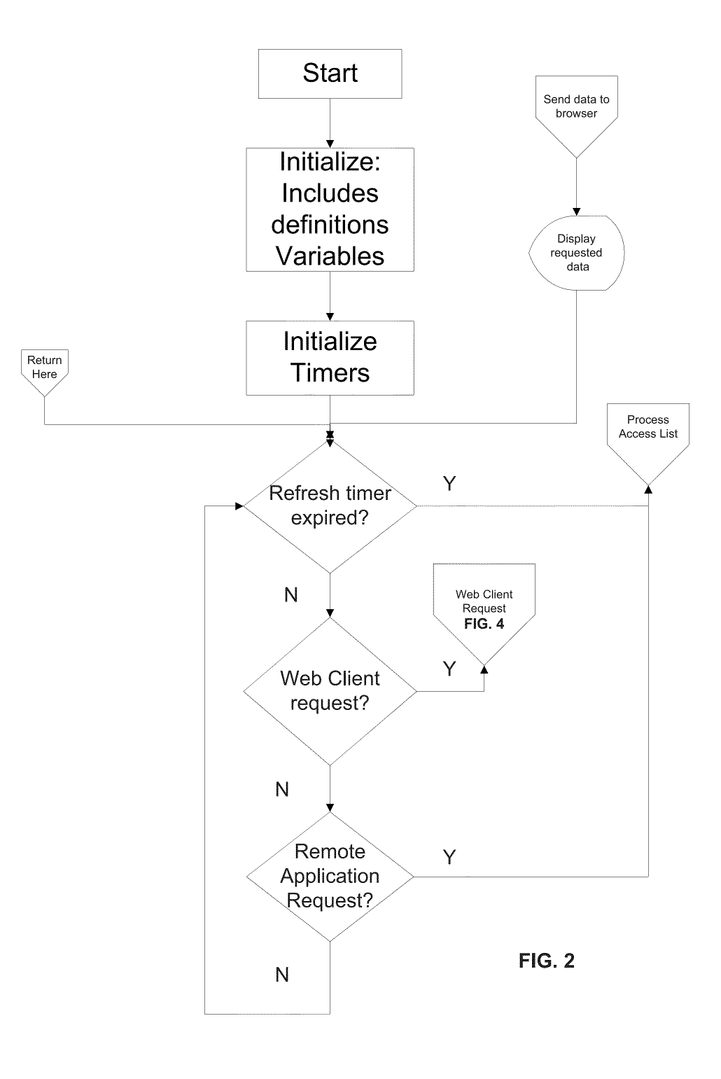

The flow chart of FIG. 2 illustrates one representative example of a subroutine for prioritizing the various external instructions received by a port redirector 34. For example, any control instruction over port 1 would be tunneled to receive priority over any other external instructions. This would allow the equipment to be effectively controlled without interruption from the other instructions. In the absence of instructions over port 1, data could be gather and logged over port 2. Associated timers could be employed to insure the port was used to collect and log data only over pre-determined time intervals. External web requests over port 3 would be permitted in the absence of traffic on ports 1 or 2. This subroutine is illustrated as only one representative example of how various instructions could be prioritized by the redirectors 34. Other subroutines could be implemented depending upon the needs dictated by the particular application.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system for prioritizing instructions related to process equipment, the system operating over a computer network and comprising:
a machine under the operation of a controller;
a series of computers for generating a plurality of instructions related to the function and operation of the machine;
a processor coupled to the controller via a data port, the processor delivering the plurality of instructions from the computers to the controller via the data port, the instructions delivered over the network in accordance with a transmission protocol;
a port redirector associated with the processor, the port redirector accepting the plurality of instructions generated by the computers, the port redirector prioritizing the plurality of instructions by determining the order in which the instructions are delivered to the data port, the prioritization being carried out in accordance with pre-determined requirements.

2. The system as described in claim 1 wherein a series of machines and a series of port redirectors are associated with the system.

3. The system as described in claim 1 wherein the data port is a parallel port.

4. The system as described in claim 1 wherein the processor communicates with the network via a wireless connection.

5. The system as described in claim 1 wherein the processor communicates with the network via a wired connection.

6. The system as described in claim 1 wherein the computers operate the machinery via a proprietary protocol.

7. The system as described in claim 1 wherein the computers allows for the machinery to be monitored over the Internet via TCP/IP.

8. The system as described in claim 1 wherein the computers operate to log data associated with the machinery.

9. The system as described in claim 1 wherein the machine is a pump and the computers monitor, the RPM of associated pump motors, flow rates, and flow pressures.

10. A system for prioritizing instructions related to process equipment, the system comprising:
a machine under the operation of a controller;
a computer for generating a plurality of instructions related to the function and operation of the machine;
a port redirector for accepting the plurality of instructions generated by the computers and prioritizing the instructions in accordance with one or more subroutines.
